(19) United States
(12) Patent Application Publication
(10) Pub. No.: US 2026/0071705 A1
(43) Pub. Date: Mar. 12, 2026

(54) QUICK CONNECTOR

(71) Applicant: A. RAYMOND ET CIE, GRENOBLE (FR)

(72) Inventors: Juergen TRIMPIN, GRENOBLE (FR); Zhen CHEN, ZHENJIANG (CN); Zhongya LI, ZHENJIANG (CN)

(21) Appl. No.: 19/320,081

(22) Filed: Sep. 5, 2025

(30) Foreign Application Priority Data
Sep. 10, 2024 (FR) 2409617

(51) Int. Cl. F16L 37/12

(52) U.S. Cl. CPC F16L 37/1225

(57) ABSTRACT

A quick connector includes: a tubular connector body defining an insertion axis and having a sealing zone in the form of an inner annular groove for receiving a male element; and an axial retaining element. The inner annular groove includes a bottom and a side wall which are defined by an inner shoulder of the main tubular connector body. The inner shoulder is not contained in a transverse plane, perpendicular to the insertion axis. The connector includes, between the axial retaining element and the bottom, at least two seals and a spacer located between the seals.

### CROSS REFERENCE TO RELATED APPLICATIONS

This application is based on and claims priority under 35 U.S.C. § 119 to French Patent Application No. 2409617, filed on Sep. 10, 2024, in the French Intellectual Property Office, the disclosure of which is incorporated by reference herein in its entirety.

### BACKGROUND

### Field

The present disclosure relates to a quick connector, for example for fluid transport pipes.

### BRIEF DESCRIPTION OF RELATED DEVELOPMENTS

In the prior art, patent EP1766282 describes a sealing sleeve intended for a fluid distribution connector. This sleeve is provided with a particular shape to reduce the force required when assembling the connector. However, there are application scenarios where a single sealing sleeve is not sufficient and where at least two seals are required to ensure appropriate tightness. The question then arises as to how to assemble at least two seals effectively while retaining the advantage of a reduced assembly force.

### SUMMARY

To overcome the above drawback, the present disclosure aims to provide a quick connector which allows the assembly of several seals while reducing the force required for this assembly. The disclosure proposes a connector configuration having a sealing zone having a 3D bottom for receiving the seals, which facilitates the insertion of a male element and reduces the force required during assembly. Furthermore, the disclosure offers the option of using seals of different materials or diameters, thus allowing adaptation to the various requirements of applications in terms of chemical and thermal resistance.

According to one aspect, the present disclosure relates to a quick connector comprising:
a tubular connector body defining an insertion axis and having a sealing zone in the form of an internal annular groove for receiving a male element;
an axial retaining element;
the inner annular groove comprising a bottom and a side wall which are defined by an inner shoulder of the main tubular connector body;
wherein the inner shoulder is not contained in a transverse plane, perpendicular to the insertion axis;
the connector comprises, between the axial retaining element and the bottom, at least two seals and a spacer located between the seals.

Optionally, the seals are, in the assembled state, capable of having the same profile as the inner shoulder.

According to one aspect, the spacer is rigid.

According to one aspect, the spacer is provided with locating means.

According to one aspect, the inner annular groove comprises an inner stop defining a stage and a second side wall.

According to one aspect, the two seals are O-rings of different diameters.

According to one aspect, the spacer is flexible.

According to one aspect, the profile of the bottom of the inner annular groove is not axisymmetric along the insertion axis of the connector.

According to one aspect, the axial retaining element comprises at least one notch.

According to one aspect, the quick connector further comprises a locking element.

According to one aspect, the at least two seals are O-rings of the same material.

According to one aspect, the at least two seals are O-rings of different materials.

According to another aspect, the present disclosure relates to a method for assembling a quick connector of the present disclosure having a flexible spacer, comprising,
(i) initially inserting the two seals into the groove of the quick connector body, said seals being separated by a spacer;
(ii) subsequently positioning the axial retaining element;
wherein the spacer deforms according to the profile of the inner shoulder during step (ii).

According to another aspect, the present disclosure relates to a method for assembling a quick connector of the present disclosure having a rigid spacer, comprising,
(i) initially inserting the two seals into the groove of the quick connector body, said seals being separated by a spacer;
(ii) subsequently positioning the axial retaining element;
wherein, during assembly, the spacer retains its original shape.

According to one aspect, the spacer is oriented in a predefined direction before it is inserted into the groove in step (i).

The advantages of the present disclosure are as follows:

The use of seals with a 3D or wave shape makes it possible to compress the seal gradually, which requires less force for assembling it in the connector. The use of two seals provides additional safety, because if one of the seals were to fail, the other would still be able to ensure tightness. The two seals may be manufactured from different materials to withstand different types of fluids, making the disclosure adapted for a variety of applications where the seals may be in contact with different fluids. The disclosure allows the use of specific materials for O-rings which can withstand extreme temperatures and aggressive chemical environments, which is particularly useful for applications such as fuel or cooling systems.

The disclosure allows the use of standard O-rings, which is economical and facilitates serial production.

The presence of a spacer between the two seals makes it possible to apply a pressure, such as compressed air, during leak tests in production, thus guaranteeing the quality of the assembly and the integrity of the seals. The use of a rigid spacer prevents rotation of components during assembly, which improves reliability.

The features of the spacer, such as locating elements, ensure correct assembly and prevent poor component orientation, which is essential for proper functioning of the assembly.

### BRIEF DESCRIPTION OF THE DRAWINGS

The disclosure can be better understood by referring to the following description and accompanying drawings which illustrate aspects of the disclosure. Among the drawings:

FIG. 1 shows a sectional view of a quick connector assembly according to one aspect of the present disclosure;

FIG. 2 illustrates a sectional view of a quick connector assembly according to another aspect of the present disclosure;

FIG. 3 shows a sectional view of a quick connector assembly of FIG. 1 in exploded form;

FIG. 4 shows a sectional view of a quick connector assembly of FIG. 1;

FIG. 5 shows a sectional view of a quick connector assembly of FIG. 4 with the sealing elements retained;

FIG. 6 shows a sectional view of a quick connector assembly of FIG. 5 with a locking element;

FIG. 7 illustrates a sectional view of a quick connector assembly of FIG. 2;

FIG. 8 shows a sectional view of a quick connector assembly of FIG. 2

FIG. 9 shows a sectional view of a quick connector assembly of FIG. 8 with the sealing elements retained;

FIG. 10 shows a sectional view of a quick connector assembly of FIG. 9 with a locking element;

FIG. 11A illustrates a perspective view of the spacer;

FIG. 11B shows a perspective view of the spacer;

FIG. 11C shows a perspective view of the flexible spacer;

FIG. 12 illustrates a perspective view of the connector body 10 of a connector 100, showing the inner annular groove and the locating means.

FIG. 13 shows a sectional view of a quick connector 100 which receives a male element; and

FIG. 14 shows a sectional view of a quick connector 100 which receives a male element, illustrating the interaction between the male element and the sealing elements.

### DETAILED DESCRIPTION

The aspects of the present disclosure are described in detail with the technical aspects, structural features, objectives achieved and effects, with reference to the accompanying drawings. More specifically, the terms used in the aspects of the present disclosure serve only to describe the purpose of a certain aspect, but do not limit the disclosure.

Expression of the singular in the present disclosure includes the plural, unless the meaning of the singular is clearly different from that of the plural in the context. In the following description, the terms “comprise” or “have” can represent the existence of a feature, a number, a step, an operation, a component, a part, or a combination thereof described in the present disclosure, and cannot exclude the existence or addition of another feature, another number, another step, another operation, another component, another part, or a combination thereof.

The terms “first” or “second” are used for the purpose of explaining various components, and the components are not limited to the terms “first” and “second”. The terms “first” and “second” are only used to distinguish one component from another. For example, a first component may be named as a second component without departing from the scope of the present disclosure.

The accompanied figures illustrate a quick connector according to the present disclosure. The quick connector illustrated is suitable for a variety of applications, including the automotive field, but not limited thereto. More specifically, the quick connector may be used in all circumstances where a first fluid line must be connected to a second fluid line. These circumstances include aircraft, motor vehicles and ships, without being limited thereto. Mention may also be made of factories, commercial areas and residential areas.

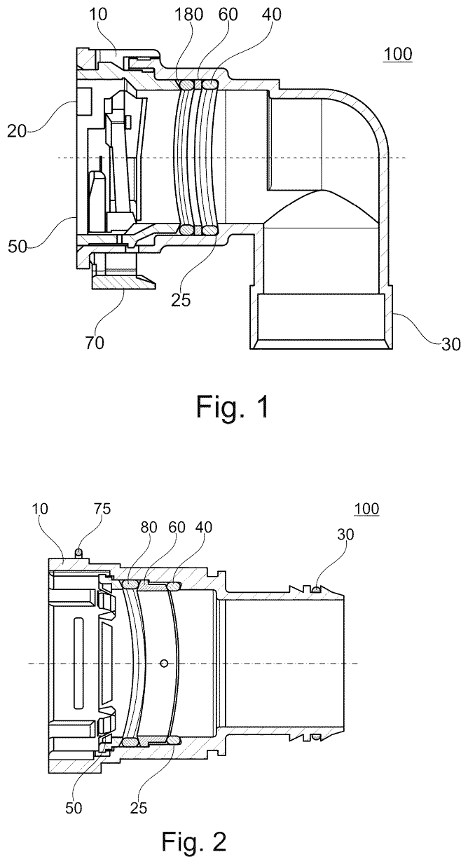

FIGS. 1 and 2 show a quick connector 100 according to one aspect of the present disclosure. With reference to FIGS. 1 and 2, the quick connector 100 comprises a connector body 10 and optionally a locking element 70, 75 mounted on the connector body 10. The connector body 10 has a first end and a second end. The first end may receive a plug-in element or a male element (not shown) and be connected to the plug-in element. The plug-in element may be in fluid communication with a first fluid duct. The plug-in element may, for example, be tubular in shape and comprise a peripheral flange on the outer periphery of the plug-in element for connection/locking with the quick connector 100. The second end 30 may be in fluid communication with a second fluid duct (such as a flexible tube). Thus, when the quick connector 100 and the plug-in element are connected/locked to each other, the first fluid duct is in communication with the second fluid duct.

FIG. 1 illustrates an exemplary aspect of a quick connector 100. The quick connector 100 comprises a tubular connector body 10 defining an insertion axis. Inside this connector body 10, an internal annular groove is formed, serving as a sealing zone 20, provided to accommodate a male element (not shown). This inner annular groove is characterized by a bottom 22 and a side wall 24, which are delimited by an inner shoulder 25 of the connector body 10. Advantageously, the inner shoulder 25 is provided so as not to be contained in a transverse plane perpendicular to the insertion axis.

Preferably, the bottom profile of the inner annular groove is not axisymmetric along the insertion axis of the connector.

Preferably, the bottom profile of the inner annular groove has a non-flat 3D profile.

Preferably, the bottom profile of the inner annular groove has an undulating shape.

Between the axial retaining element 50 and the bottom 22 of the groove, the quick connector 100 comprises at least two seals, identified as the first seal 40 and the second seal 80, with a spacer 60 located between them. The spacer 60 serves to maintain appropriate spacing between the two seals 40, 80 and may deform according to the profile of the inner shoulder during assembly.

In this aspect, the spacer is flexible.

Preferably, a locking element 70 is also present to secure the quick connector 100 assembly.

In one advantageous aspect, the two seals 40, 60 are O-rings.

FIG. 2 shows an aspect of a quick connector 100 with a rigid spacer 60. The quick connector 100 comprises a tubular connector body 10. Inside the connector body 10, two seals, the first seal 40 and the second seal 80, are positioned and separated by the rigid spacer 60. This spacer 60 maintains a spacing between the two seals, which is essential for their effective operation.

In one advantageous aspect, the two seals 40, 80 are O-rings.

The rigid spacer 60 offers the advantage of stabilizing the O-rings during assembly and pressure tests, thus preventing their movement or rotation, which could otherwise compromise the tightness of the connector.

FIG. 2 also shows the undulating shape of the O-ring 80, which can allow gradual compression of the seal during assembly, thus reducing the force required and improving tightness. This will be detailed later on.

This aspect with the rigid spacer 60 is particularly advantageous because it offers increased safety thanks to the double sealing barrier formed by the two O-rings, while enabling an effective leak test by applying a pressure between the seals during production tests.

The present disclosure also allows the use of standard components, such as standard O-rings, which is economical and facilitates serial production. Furthermore, the rigid spacer 60 helps to ensure correct assembly and prevents poor component orientation.

Optionally, two notches (not illustrated) located on the outer periphery of the retaining element 50 are provided to fit into openings present on the connection end of the body 10, thus keeping the retaining element 50 clipped into the main body 10. Alternatively, the axial retaining element may be a connector head assembled to the connector body.

Locating pins make it possible to insert the spacer 60 into the body 10 with a precise angular orientation, by sliding in grooves located on the body 10. This will be detailed later on.

A flexible spacer means a component intended to adapt to variations in profile within the connector body during assembly. It may deform to mold the contours of the inner annular groove and the bottom profile of this groove, even if this profile is not axisymmetric along the insertion axis of the connector. The flexible spacer may be manufactured from materials having a low rigidity obtained by a compromise between the dimensions and the Young's modulus of the material, for example elastomeric materials or other flexible materials allowing it to adjust to irregularities while maintaining an appropriate compressive force on the O-rings that it separates.

A rigid spacer means a component that maintains fixed and precise spacing between the O-rings within the inner annular groove of the connector body. Unlike a flexible spacer, a rigid spacer is made from materials which have greater thicknesses and use materials with a high Young's modulus, which gives it a high rigidity, such as technical plastics or metals, which do not deform under assembly pressure or during use of the connector. The rigid spacer is designed to withstand mechanical forces without altering its shape, thus ensuring constant alignment and separation of the O-rings, even in the presence of non-axisymmetric groove bottom profiles.

In the example of FIGS. 1 and 2, the axial retaining element 50 comprises a first segment and a second segment, the end of which compresses the second O-ring 80. Therefore, the length of the second segment varies according to the radial orientation. Advantageously, the first segment has a greater outer diameter than the second segment. This difference in diameter exposes a peripheral edge of the first segment of the retaining element 50, which can bear against a stop shoulder of the main body. This facilitates the positioning of the axial retaining element 50.

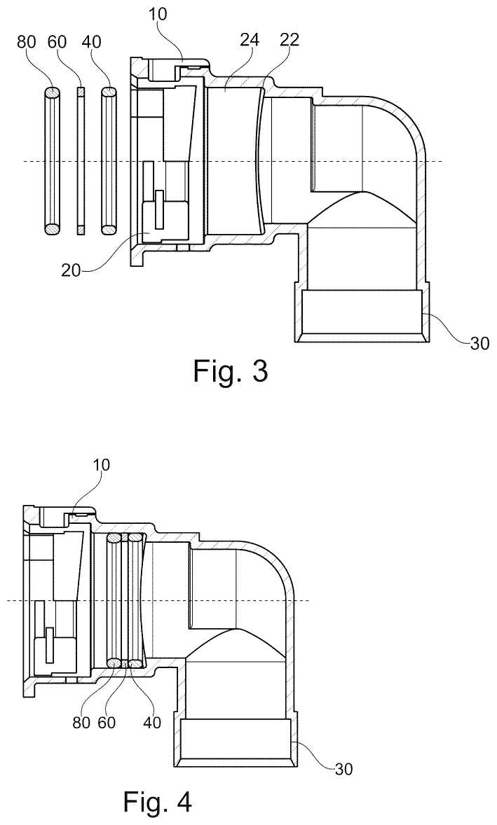

FIG. 3 shows a sectional view of a quick connector, illustrating a similar aspect to that described in FIG. 1, but shown in exploded view form. In this view, the first O-ring 40 and the second O-ring 80 are separated by the spacer 60. The flexible spacer 60 is provided to maintain appropriate spacing between the two O-rings.

FIG. 4 illustrates the process of introducing the sealing components 40, 60, 80 into the tubular connector body 10. The first O-ring 40, the spacer 60, and the second O-ring 80 are placed in the inner annular groove 20, either sequentially, or together as a unit using a dedicated tool. This step prepares the connector for the insertion of the retaining element 50. The spacer 60 is flexible in this aspect.

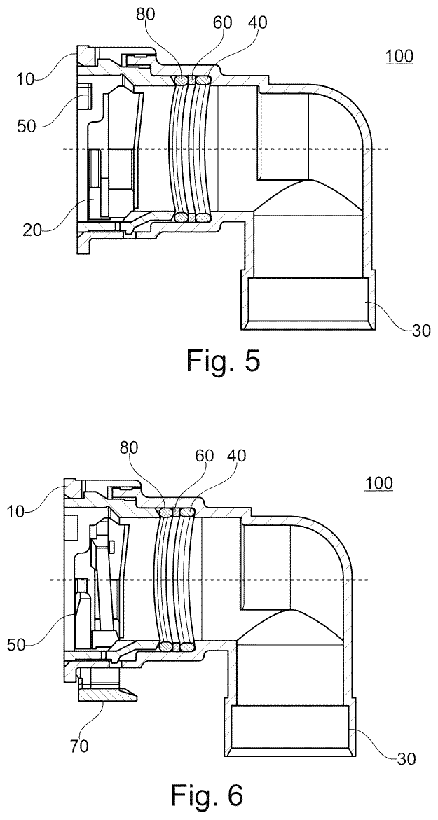

FIG. 5 shows the insertion of the retaining element 50 into the connector body 10, where it compresses the second O-ring 80 against the bottom of the inner annular groove 20. The spacer 60, being flexible, adapts to the profile of the inner shoulder during this compression. FIG. 5 advantageously illustrates the fit between the profile of the bottom of the inner annular groove 20, and the corresponding end of the retaining element 50, thus ensuring reliable retention and effective tightness.

The sealing components, comprising the first O-ring 40, the spacer 60, and the second O-ring 80, are inserted into the inner annular groove 20 of the connector 100, either one by one, or simultaneously as a unit, using a specific tool, as shown in FIG. 4. Subsequently, the retaining element 50 is positioned, exerting pressure on the second O-ring 80. The spacer 60, of flexible type, allows the three elements 40, 60, 80 to be compressed together between the bottom of the inner annular groove 20 and the retaining element 50. This configuration is advantageous, because the profile of the bottom of the inner annular groove 20 is provided to match that of the end of the retaining element 50, thus ensuring appropriate tightness and attachment, as illustrated in FIG. 5.

FIG. 6 shows a sectional view of a quick connector 100, showing the addition of a locking element 70. This locking element is provided for securing the retaining element 50 in place and/or for locking the male element (not illustrated) when inserted into the connector body 10. FIG. 6 illustrates the position and function of the locking element 70 within the quick connector assembly 100.

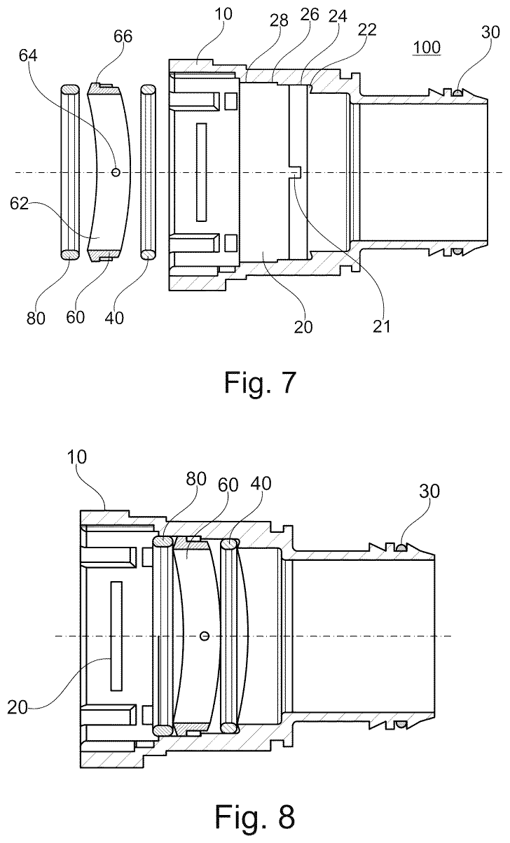

FIG. 7 shows a sectional view of a quick connector, illustrating a similar aspect to that described in FIG. 2, but shown in exploded view form. The elements are disposed so as to show their relative arrangement before assembly.

In this view, the first O-ring 40 and the second O-ring 80 are separated by the spacer 60. The spacer 60 is provided to maintain appropriate spacing between the two O-rings, and ensures proper alignment and stability of the O-rings within the connector body 10.

The exploded view makes it possible to understand the spatial relationship between the different components of the quick connector 100 and the manner in which they are assembled to form the assembly.

The connector body houses an inner annular groove, at the bottom of which the bottom 22 is located. The side wall 24 of the groove, together with the bottom 22, forming the inner shoulder 25, delimits the space wherein the first seal will be placed.

The inner annular groove includes a stage 26, which, in cooperation with the second side wall 28, provides precise and stable positioning for the spacer 60 and the second seal 80. The first end of the spacer 62 is provided to fit against the bottom 22, thus ensuring appropriate compression of the first seal during assembly.

FIG. 8 illustrates the process of introducing the sealing components into the tubular connector body 10. The first O-ring 40, the spacer 60, and the second O-ring 80 are placed in the inner annular groove 20, either sequentially, or together as a unit using a dedicated tool for example. This step prepares the connector for the insertion of the retaining element 50. The spacer 60 is rigid in this aspect.

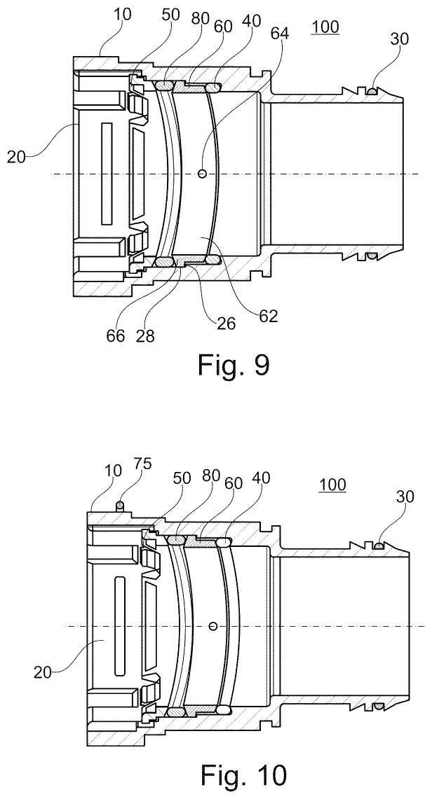

FIG. 9 shows the insertion of the retaining element 50 into the connector body 10, where it compresses the second O-ring 80 against the bottom of the inner annular groove 20. The spacer 60, being rigid, compresses the first O-ring 40 against the bottom and the first seal adapts to the profile of the inner shoulder during this compression. FIG. 9 highlights the correspondence of the profiles between the bottom of the inner annular groove 20 and one end of the retaining element 50, thus ensuring good retention and effective tightness.

The spacer 60, of rigid type, allows the two elements 40, 80 to be compressed together between the bottom of the inner annular groove 20 and the retaining element 50. This configuration is advantageous, because the profile of the bottom of the inner annular groove 20 is provided to match that of the end of the retaining element 50, thus ensuring appropriate tightness and attachment, as illustrated in FIG. 9.

In FIG. 9, the inner annular groove 20 of the connector body 10 is characterized by a stage defined by a stop 26 and a second side wall 28. Advantageously, the stage 26, 28 cooperates with the rigid spacer for its positioning in the annular groove 20. The rigid spacer 60, when inserted into the annular groove 20, is aligned with the stage 26 and the side wall 28, which contributes to the structural stability of the assembly and to the precision of the alignment of the sealing components.

In this aspect, it is advantageous that the two O-rings 40, 80 have different diameters. More specifically, the diameter of the second O-ring 80 is greater than that of the first O-ring 40.

The spacer 60, rigid or flexible, comprises the orientation means 64 on the inner surface, which may be a specific shape or a known structure making it possible to cooperate with an assembly tool. This tool makes it possible to position the spacer 60 in the desired orientation inside the connector.

To check tightness during assembly, controlled pressure can be applied to ensure the integrity of the seals separated by the spacer. Advantageously, the spacer 60 plays an essential role in the process of verifying the tightness of the quick connector 100 during assembly, thus ensuring that the finished product meets the required quality and performance standards.

FIG. 10 shows a sectional view of a quick connector 100, showing the addition of a locking element such as a U-clip 75, which may be metallic, which can be inserted into the grooves provided in order to hold the retaining element 50 firmly.

This locking element 75 is provided for securing the retaining element 50 in place and/or for locking the male element (not illustrated) when inserted into the connector body 10.

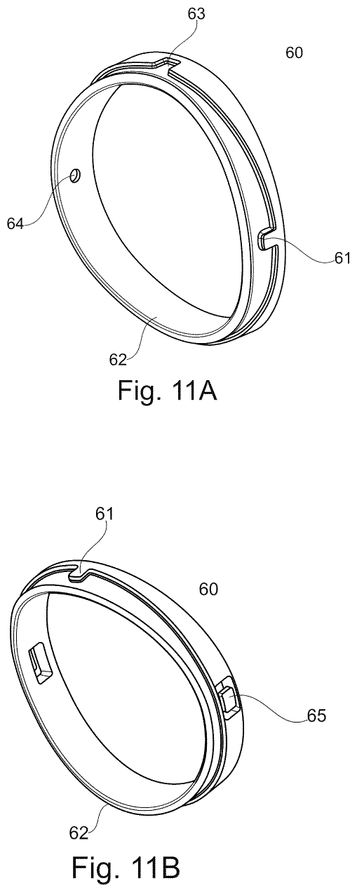

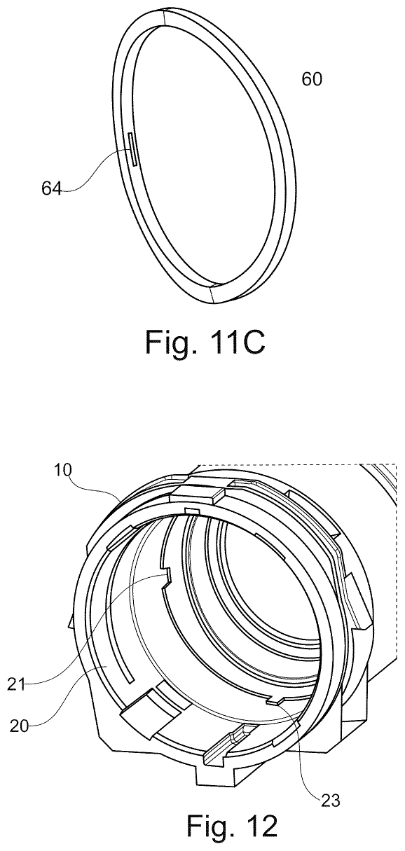

FIG. 11A shows a perspective view of the spacer 60, illustrating an aspect of the spacer used in the quick connector. The spacer 60 is provided with locating pins 61, 63, which facilitate the correct orientation of the spacer when it is inserted into the connector body 10. The first end of the spacer 62, is provided to compress the first O-ring 40 during assembly, thus ensuring appropriate tightness between the components of the connector.

FIG. 11B also shows a perspective view of the spacer 60, showing another aspect. As in FIG. 11A, this spacer 60 is equipped with locating pins 61, which assist with precise alignment of the spacer during insertion. The first end 62 of the spacer 60 exerts pressure on the first O-ring 40 during assembly, helping create an effective tightness barrier. Furthermore, the spacer 60 has retaining means 65, which could be notches, hooks or any other mechanism adapted to hold the spacer firmly in position within the inner annular groove 20.

FIG. 11C shows a perspective view of the rigid spacer 60. The rigid spacer 60 is devoid of a stop. The orientation means 64, located on the inner surface of the spacer 60, make it possible to position the spacer in the desired orientation using a tool during assembly.

FIG. 12 illustrates a perspective view of the body 10 of a connector 100. The connector body 10 has, inside the inner annular groove, the locating means 21, 23 such as grooves for cooperating with the locating pins of the spacer 61, 63, not illustrated in this figure, when inserting the spacer into the connector body 10. This cooperation ensures precise alignment and prevents incorrect spacer insertion, thus contributing to connector assembly reliability and performance. The overall configuration ensures appropriate alignment and stability of the components within the connector assembly.

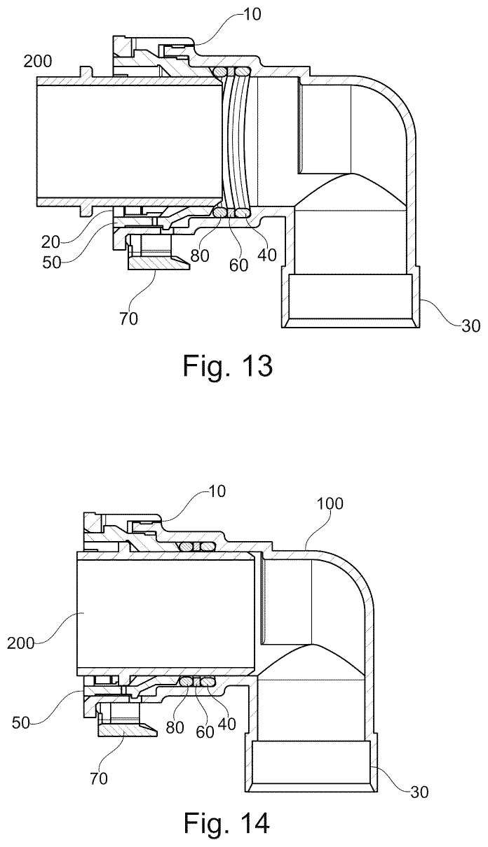

FIG. 13 shows a sectional view of a quick connector 100. The connector body 10 houses the retaining element 50, which ensures the attachment of the assembly. The first O-ring 40 and the second O-ring 80 are positioned inside the connector body 10, separated by the spacer 60. Optionally, a locking mechanism 70 ensures that the components remain securely in place inside the quick connector 100 assembly.

A male element 200 is inserted into the annular groove 20.

Then, as illustrated by FIG. 14, the penetrating end of the male element 200 comes into initial contact with the second O-ring 80 on a portion of its periphery. As the male element 200 is inserted farther into the connector body 10, the contact surface area with the second O-ring 80 increases, causing gradual compression of the seal. This gradual compression reduces the force required to fully insert the male element 200, compared to a scenario where the seal was compressed uniformly over its entire periphery from the start of insertion. The bottom of the annular groove may be associated with the undulating shape of the seal 80, has a wave shape varying sinusoidally, allowing this gradual compression.

Advantageously, the use of two seals provides additional safety, because if one of the seals were to fail, the other would still be able to ensure tightness.

Advantageously, the O-rings are made of the same material.

This provides a reliable and redundant connection to ensure tightness.

Advantageously, the O-rings are made of different materials.

This makes it possible to ensure thermal and chemical compatibility. Indeed: The disclosure allows the use of specific materials for O-rings which can withstand extreme temperatures and aggressive chemical environments, which is particularly useful for applications such as fuel or cooling systems.

LIST OF REFERENCE SIGNS

| Reference | |
|---|---|
| sign | Description |
| 100 | Connector |
| 10 | Tubular connector body |
| 20 | Inner annular groove/ |
| | Sealing zone |
| 21 | Groove/Locating means |
| 22 | Bottom |
| | Groove/Locating means |
| 24 | Side wall |
| 26 | Stage |
| 25 | Inner shoulder |
| 28 | Second side wall |
| 30 | Connector end |
| 40 | First seal |
| 50 | Axial retaining element |
| 60 | Spacer |
| 61 | Locating means |
| 62 | First end of spacer |
| 63 | Locating means |
| 64 | Orientation shape |
| 65 | Retaining means |
| 66 | Reduced spacer |
| | cross-section |
| 70 | Locking element |
| 75 | Locking element |
| 80 | Second seal |

What is claimed is:

1. A quick connector-comprising:
a tubular connector body-defining an insertion axis and having a sealing zone in the form of an inner annular groove for receiving a male element;
an axial retaining element;
the inner annular groove comprising a bottom and a side wall which are defined by an inner shoulder of the main tubular connector body;
characterized in that
the inner shoulder is not contained in a transverse plane, perpendicular to the insertion axis;
the connector comprises, between the axial retaining element and the bottom, at least two seals and a flexible or rigid spacer located between the seals which are capable of having the same profile as the inner shoulder.

2. The quick connector according to claim 1, wherein the rigid spacer is provided with locating means.

3. The quick connector according to claim 1, wherein the inner annular groove comprises an inner stop defining a stage and a second side wall.

4. The quick connector according to claim 1, wherein the two seals are O-rings of different diameters.

5. The quick connector according to claim 1, wherein the profile of the bottom of the inner annular groove is not axisymmetric along the insertion axis of the connector.

6. The quick connector according to claim 1, wherein the axial retaining element comprises at least one notch.

7. The quick connector according to claim 1, further comprising a locking element.

8. The quick connector according to claim 1, wherein the at least two seals are O-rings made of the same material.

9. The quick connector according to claim 1, wherein the at least two seals are O-rings made of different materials.

10. A method for assembling a quick connector according to claim 1, comprising:
(i) initially inserting the two seals into the groove of the quick connector body, said seals being separated by a spacer; and
(ii) subsequently positioning the axial retaining element;
wherein the spacer deforms according to the profile of the inner shoulder during step.

11. A method for assembling a quick connector according to claim 1, comprising:
(i) initially inserting the two seals into the groove of the quick connector body, said seals being separated by a spacer; and
(ii) subsequently positioning the axial retaining element;
wherein, during assembly, the spacer retains its original shape.

12. The method for assembling a quick connector according to claim 11, wherein the spacer is oriented in a predefined direction before it is inserted into the groove in step (i).
